(19) United States
(12) Patent Application Publication
(10) Pub. No.: US 2002/0104228 A1
(43) Pub. Date: Aug. 8, 2002

(54) Template for matching any wallcovering pattern used to cover wall plates with the wallcovering pattern adjacent to said wall plates

(76) Inventor: D. James Hill, Medford, NJ (US)

Correspondence Address: D. James Hill, 24 Golfview Drive, Medford, NJ, 08055, US

(21) Appl. No.: 09/778,626

(22) Filed: Feb. 8, 2001

(51) Int. Cl. B43L 13/20

(52) U.S. Cl. 33/566; 33/528; 33/645; 33/DIG. 10

(57) ABSTRACT

A template to guide wallcovering applicators, be they professional or amateur, in the matching and cutting of any patterned wallcovering used to cover electrical switch and/or receptacle plates with the same patterned wallcovering applied to the wall contiguous to said wall plates.

### BACKGROUND OF THE INVENTION

Switch and receptacle plates are mandated by building code law in every nation on the globe where electricity is available.

The average home now being built in America has over 150 wall plates, primarily mandated, with some extra wall plates installed for owner convenience.

Globally, hundreds of millions of wall plates are sold annually, with an increasing number of them wrapped in wallpaper, or, as with recent wall plate design, having a transparent-plastic-shielded insert that is commonly a patterned wallpaper to match the pattern of the wallpaper around the wall plate.

Whether the patterned wallpaper is cut to wrap around the wall plate or cut to insert into a decor-shielded wall plate, matching the pattern of the wallpaper cut for the wall plate with the pattern of the wallpaper surrounding the wall plate is commonly a trial-and-error, time consuming task for even professional wallcovering applicators. Pattern-matching for the non-professional applicator is commonly accomplished only after cutting-and-trying several times to gain an imperfect but acceptable match.

This invention organizes the steps to a flawless, first time, every time matching of remotely-cut patterned wallcovering that is to be applied on wall plates surrounded by the same patterned wallcovering on a finished wall.

### SPECIFICATION

A template of transparent plastic with,

1. (a) various holes die cut therein, said holes configured to match various electrical switch and/or receptacle configurations including attachment screw and other holes,

(b) with various printing thereon to guide the user to the impermanent attachment of the template to the desired installed switches, receptacles or combinations thereof on a wall on which wallcovering has been applied,

(c) said transparent template surface-textured to allow the user, when template is secured over the desired combination of switches and/or receptacles, to pencil-mark certain chosen pattern-keys on the template over the wallcovering thereunder at points near the periphery of the template.

2. Detached from chosen switch and/or receptacle combinations, said template is,

(a) taken to the identical wallcovering and pattern unrolled flat on a table-like surface,

(b) momentarily attached with drafting tape over the same pattern keys on the identical wallcovering,

(c) the template openings for switches and/or receptacles, and the perimeter of the wallcovering to be cut for said wall plates are pencil-marked on said wallcovering,

(d) the attachment tape and template are removed from the wallcovering, pencil markings erased for the template's reuse,

(e) and the matching pattern wallcovering insert or cover is cut for use in or on the wall plate, depending on the wall plate assembly design configuration.

### BRIEF DESCRIPTION OF THE DRAWINGS

A more complete understanding of this invention and its advantages will be apparent from the detailed description when related to the following drawings in which:

FIG. 1 Is a front elevation of this invention.

FIG. 2 Is a front elevational view of this invention temporarily attached on a double switch combination and over an applied patterned wallcovering with the pattern keys pencil-drawn on the template.

FIG. 3 Is a down-looking view of this invention positioned and temporarily corner-taped over the same pattern on an identical wallcovering material on a table-like surface remote from the double switches and applied wallcovering, having the four corner cut-keys penciled in on the rolled-out wallcovering.

FIG. 4 Is another down-looking view of that same corner-marked wallcovering with the wall plate assembly decor backer-plate temporarily drafting-tape-secured within the four corner cut-keys preparatory to using the decor backer-plate as a template for using a razor-pointed knife to cut the matched pattern insert for the double switch plate.

FIG. 5. Is a front elevational view of the cut pattern-matched wallcovering that is the insert now enclosed and shielded in the wall plate assembly mounted on the two switches. The screws attaching this assembly to the switches are concealed.

FIG. 6 is a cross sectional view of this invention attached to a switch by means of a temporary attachment fastener.

### DETAILED DESCRIPTION

FIG. 1 referring in detail to the drawings, this invention includes the transparent template 1 on which are the switch openings 2, receptacle openings 3, attachment openings 4, cut-guideline openings 5 for conventional wall plate cover-wrapping, cut guideline curved slot openings 6 for custom wall plate inserts, and graphic outline guides 7 delineating the several switch and/or receptacle combinations included in this one template tool.

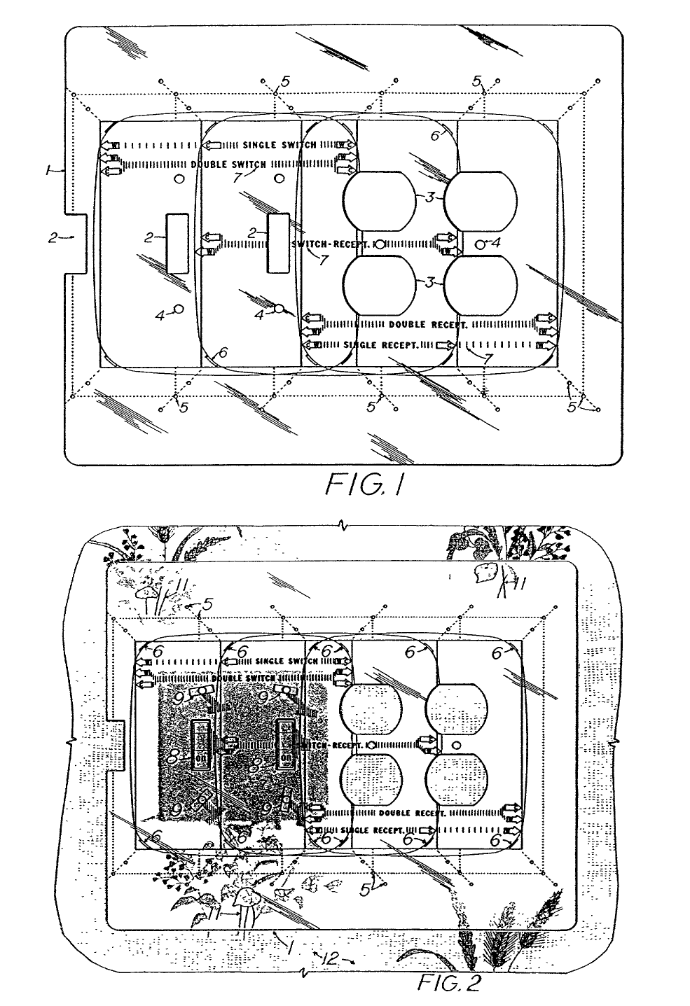

FIG. 2 is an elevational view of this invention showing the template 1 mounted over a double switch 8 around which wallcovering 12 is applied to the wall, the template 1 attached to the switch 8 mechanism by means of temporary attachment fasteners 9.

Three pattern-key elements 11 of the surrounding wallcovering 12 are shown pencil-drawn in outline on the template 1 over the outline of the pattern-key figures on the wallcovering 12 thereunder..

FIG. 3 illustrates the template 1 with the pattern-key elements 11 of wallcovering identical to but remote from the wallcovering in FIG. 2 pencil-drawn on the template 1, said template 1 temporarily taped over the pattern of the remote wallcovering 12 exactly matching that immediately surrounding the double switch openings 2 in the template, said openings shown astride the double switches illustrated in FIG. 2.

Wallcovering cut-key guideline openings 5 marking the four corners of the matching wallcovering to be cut to wrap a conventional wall plate are shown.

For cutting a match-pattern insert for wall plates designed to enclose and shield that wallcovering insert, only the pencil-marking of the four curved cut-key corners 6 on the underlaying wallcovering 12 is necessary to accurately cut said match-patterned insert.

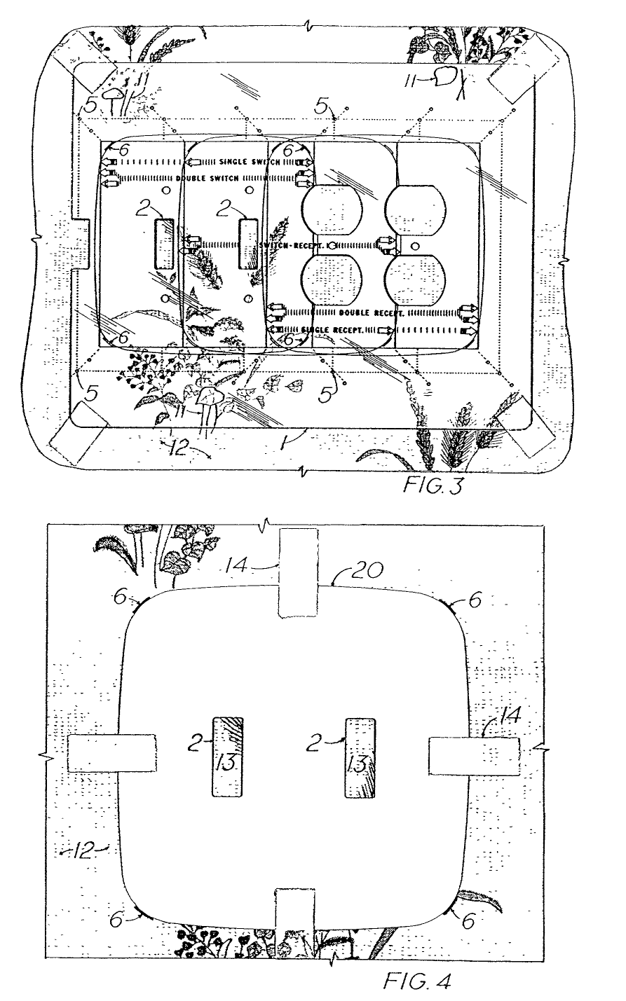

FIG. 4 illustrates a double switch decor backer-plate 20 centered within the four curved cut-key corners 6 penciled on the patterned wallcovering 12 that the template which is the centerpiece of this invention has located on the remote rolled-out same-pattern wallcovering 12.

The pattern-matched insert thereunder 13 can now be cut in a variety of ways. A recommended method is scissor-cutting a two-inch-oversized piece of the wallcovering 12 in which the decor backer-plate 20, taped to and centered in the four cut-key corners which exactly outline the corners of the desired pattern-matched insert 13, is cut out of the rolled-out wallcovering 12. Using a razor-point blade, with the decor backer-plate 20 as a template taped 14 over the pattern-matched insert 13, and with an out-dated magazine as a cutting board, first cutting the two switch holes 2.

Finally, cutting the perimeter of the insert 13, using the edge of the periphery of the decor backer-plate 20 as a guide, but cutting the wallcovering under the four strips of tape 14 one at a time, replacing each strip of tape 14 after the wallcovering under its position is cut when the remainder of the insert's 13 perimeter is cut.

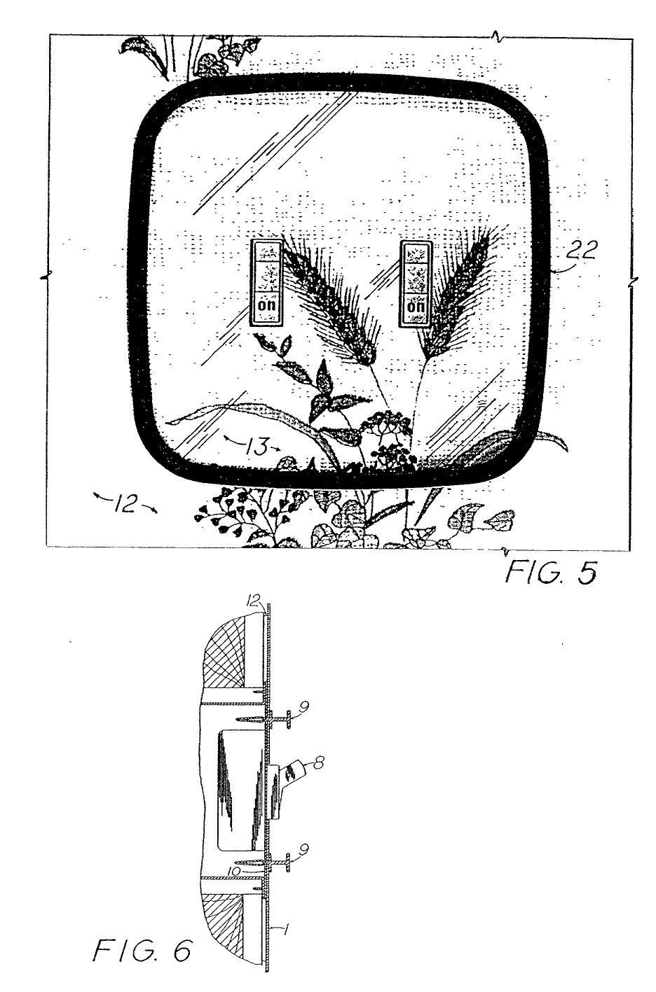

FIG. 5 illustrates the matched-pattern wallcovering insert 13 shielded in a wall plate assembly 22, the pattern match of the insert 13 and the adjacent wallcovering 12 now being clear.

FIG. 6 is a cross sectional view of one quick-attachment type of fastener 9 temporarily securing the template 1 to a switch 8 and over the wallcovering 12.

The template 1 may also be temporarily attached to switches 8 and/or receptacles by means of the flathead screws that are included with the wall plate assembly 22.

Many modifications can be made in the exemplary structure described above without exceeding the scope of the present invention. The invention is applicable also to switches and receptacles of any configuration and the cover plates therefor by simply producing the tool of a different size and holes configuration.

While a certain embodiment of the present invention has been described in detail herein and shown in the accompanying drawings, it is obvious that minor changes may be made in the form and construction of the invention without departing from the material spirit thereof.

What is claimed:

1. A translucent plastic template comprised of a finely textured front surface, a printed back surface on which are permanently printed linear outlines of certain artifacts, patterns and descriptions related thereto, apertures fitting various artifacts, projections or portions thereof, coordinated with apertures for attachment means, cut-guides and the like.

2. A flat, translucent plastic template of a size to cover numerous combinations of electric switches and/or receptacles mounted in and attached to appropriately protective boxes in building walls having patterned wallcovering thereon,
a. said template having a glossy smooth back-plane surface on which is reverse-printed the outline of switch and receptacle plates (hereinafter referred to as wall plates) combined with basic instructions relating to the identifying of said individual wall plate outlines and combinations thereof,
b. said template having apertures configured to fit closely over and around said wall-mounted switch(es) and/or receptacle(s), placing template proximate to surrounding wall with patterned wallcovering thereon,
c. said template further having round apertures aligned with the switch and/or receptacle wall plate attachment-screw apertures into some of which attachment means are inserted to attach template temporarily to switch(es) and/or receptacles(s),
d. said template further having narrow apertures at corners of the peripheries of printed wall plate outlines wherein match-pattern-cut wallcovering is to be enclosed in said wall plate assembly, while
e. said template further has numerous small circular apertures in a pattern extending diagonally out from the peripheral corners of template's several individual wall plate outlines, said apertures to facilitate the accurate pencil-graphite mark-keying of the corners of match-pattern wallcovering wrap-over of the face and edges of conventional wall plates,
f. said template having a finely textured front-plane surface whereon, when said template is temporarily but stably attached to wall-mounted switch(es) and/or receptacles(s) surrounded by patterned-wallcovering-wall, pencil-graphite is used to erasably outline three or more widely separated pattern-match-keys at or near the perimeter of said template,
g. said template, pattern-match-keyed and detached from wall-mounted switch(es) and/or receptacle(s),is placed over and tape-attached to same-patterned wallcovering held flat on a work table, whereon said template pencil-graphite-marked pattern-match-keys are positioned exactly over identical pattern on tabled and flat wallcovering,
h. said template's cut-guide apertures determining the placement of pencil-graphite marking the later positioning of wall plate's decor plate,
i. herein temporarily but stably taped within said pencil-graphite-marked corners on tabled and flat wallcovering to function as a template for cutting the switch and/or receptacle apertures and perimeter of the pattern-matched wall plate decor insert.

3. A translucent plastic template comprised of:
a. a front surface finely textured whereon pencil-graphite will erasably adhere,
b. a glossy smooth back surface on which are permanently printed linear outlines of selected artifacts, patterns and descriptions related thereto,
c. apertures coordinated with said printing and fitting various artifacts, projections or portions thereof, for cut-guides and the like,
d. coordinated with apertures for fasteners with which to detachably attach said template to selected individual or multiple artifacts thereunder,
e. pencil-graphite-marking said template front surface to outline-duplicate multiple, near-template-periphery patterns on patterned substratum,
f. said template, (i) pattern-match-keys pencil-graphite-marked thereon, (ii) detached from artifact(s) noted in (d) above, (iii) positioned with pattern-match-keys directly over identical pattern configurations on table-mounted, held-flat wallcovering, (iiii) temporarily but stably attached thereto, and (iiiii) with appropriate cut-guides pencil-graphite-marked on patterned substratum thereunder, said exact pattern-matched-cut is thus delineated on the patterned wallcovering.
